(19) United States
(12) Patent Application Publication
(10) Pub. No.: US 2006/0047346 A1
(43) Pub. Date: Mar. 2, 2006

(54) Private video recorder providing user interface showing history of storing status of content and method therefor

(75) Inventors: Min-ju Yim, Swon-si (KR); Eun-hyung Kim, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/210,822

(22) Filed: Aug. 25, 2005

(30) Foreign Application Priority Data
Aug. 25, 2004 (KR) 2004-0067081

(51) Int. Cl. G05B 19/18

(52) U.S. Cl. 700/2

(57) ABSTRACT

A private video recorder (PVR) providing a user interface showing a history of a storing status of content and a method therefor. The private video recorder includes a receiving module receiving content from a content source, a decoding module decoding the received content in an outputable form, a display module outputting the decoded content, a storage module storing at least one of the received content and the decoded content, an input module receiving data for operation control from a user, a control module controlling operations of the receiving module, the decoding module, the display module and the storage module according to the data for operation control received from the input module, and a user interface module generating a user interface showing a history of a storing status in the storage module and providing the user interface to the display module.

This application claims priority from Korean Patent Application No. 10-2004-0067081 filed on Aug. 25, 2004 in the Korean Intellectual Property Office, the disclosure of which is incorporated herein by reference in its entirety.

### BACKGROUND OF THE INVENTION

1. Field of the Invention

The present invention relates to a private video recorder and a method therefor, and more particularly, to a private video recorder that provides a user interface showing the history of storing status of content so that a user can know current storing status of content even when an old portion of the content is overwritten by a new portion of the content in a limited storage space, and a method for controlling the private video recorder.

2. Description of the Related Art

Apparatuses for recording digital video may be largely divided into hard disc recorders (HDRs) and digital video recorder (DVRs). An HDR stores video in a hard disc and reproduces it. An HDR is similar to an existing analog video cassette recorder (VCR). A DVR is referred to as a private video recorder (PVR) and is like an HDR that has a control function like a computer and an additional function such as an electronic program guide.

A PVR shows information such as a weekly broadcast schedule, the channel of preference, and a program guide by genre and provides functions such as timer recording, pause of a live program, recording during the pause of a live program, reviewing of a previously-recorded part, and 32× search. In particular, a PVR provides diverse advantages including a time shifting function that pauses a currently viewed live TV program and accesses a stored program or records a plurality of programs simultaneously.

A PVR displays information such as a program guide by genre or operating status thereof and storing status of content when a program is recorded using time shifting on a screen of a display apparatus. This operation is referred to as On Screen Display (OSD). The OSD is a function that directly displays information which a user needs or should know on a screen of a display apparatus. Information displayed in OSD includes the brightness and contrast of a screen, tuning, RGB adjustment, and adjustment of the size and position of the screen in upper, lower, left and right directions. Generally, the OSD displays the progression of adjustment on a screen. A PVR can show operating status thereof and storing status of a program using the OSD.

FIGS. 1A and 1B illustrate user interfaces showing operating status and storing status of content in a conventional PVR. U.S. Pat. No. D435,561 can be referred to for the detailed description of the user interfaces.

FIG. 1A illustrates a status bar indicating the status of a live TV program in OSD. The status bar includes a bar 110 indicating time, a section 120 denoting the amount of content temporarily stored and recorded, a line 130 indicating a position that is currently played, a section 140 indicating current running time, and an icon 150 indicating current operating status. The bar 110 indicating the time displays a start time 111 and a storable time 112. Referring to FIG. 1B, the bar 110 may display entire recorded time ranging between sections 113 and 114 when a recorded program is played. The right end of the section 120 denoting the amount of recorded content displays a position that is broadcast live. The section 140 indicating the current running time displays a current time of a live broadcast program. The icon 150 indicating the current operating status displays the operating status of the PVR, such as Play, Pause, Rewind, or Fast Forward

FIG. 1B illustrates a state where a Rewind button is pressed while a 2-hour recorded program is being played.

In the operation of a conventional user interface, when a user presses a Pause button while watching a TV program, a screen image stops and an OSD user interface as shown in FIG. 1A is displayed on a lower portion of a screen. The section 120 denoting the amount of content temporarily stored and recorded increases and shows a time corresponding to a portion stored in a hard disc. When the user presses a Play button, the TV program is played again starting from a position where the play was stopped before and the line 130 indicates a position of recorded part that is currently played. When the line 130 indicating a position currently played reaches the end of the section 120 indicating the amount of recorded content through the operation of the Play or Fast Forward button, currently broadcast live TV is returned and the OSD user interface disappears.

When such conventional OSD user interface is used, overwriting may be performed to continuously store a program in a limited hard disc. When the overwriting is performed, the conventional OSD user interface cannot display that the overwriting has been done, and therefore, a user cannot know which part of a program is being recorded.

### SUMMARY OF THE INVENTION

The present invention provides a private video recorder providing a user interface showing a history of a storing status of a content and an operating status of the private video recorder so that a user can exactly recognize a portion that is currently recorded and a portion that is currently played.

The above stated object as well as other objects, features and advantages, of the present invention will become clear to those skilled in the art upon review of the following description.

According to an aspect of the present invention, there is provided a private video recorder, including a receiving module receiving content from a content source, a decoding module decoding the received content, a display module outputting the decoded content, a storage module storing at least one of the received content and the decoded content, an input module receiving data for operation control from a user, a control module controlling operations of the receiving module, the decoding module, the display module, and the storage module according to the data for operation control received from the input module, and a user interface module generating a user interface showing a history of a storing status in the storage module and providing the user interface to the display module.

According to another aspect of the present invention, there is provided a method of providing a user interface showing a history of a storing status of a content in a private video recorder, the method including receiving content from a content source, decoding the received content, receiving data for operation control from a user, controlling operations of the private video recorder according to the data for operation control, generating the user interface showing the history of the storing status according to the controlled operations, and outputting the decoded content and the user interface.

### BRIEF DESCRIPTION OF THE DRAWINGS

The above and other features and advantages of the present invention will become more apparent by describing in detail non-limiting exemplary embodiments thereof with reference to the attached drawings in which:

FIGS. 1A and 1B illustrate user interfaces showing operating status and storing status of content in a conventional private video recorder (PVR);

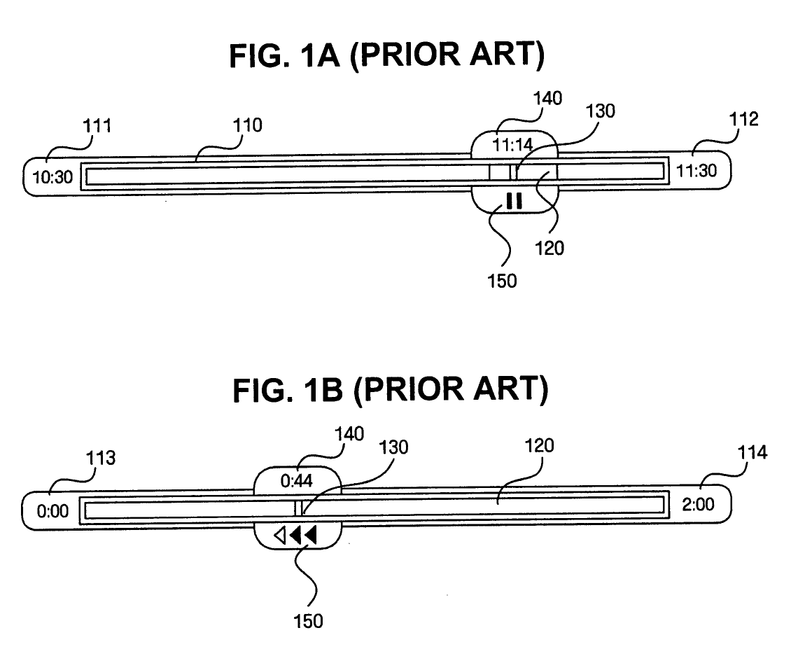

FIG. 2 illustrates a system environment, including a PVR consistent with an exemplary embodiment of the present invention;

FIG. 3 is a block diagram of a PVR consistent with an exemplary embodiment of the present invention;

FIG. 4 is a flowchart of the operations of a PVR consistent with an exemplary embodiment of the present invention;

FIG. 5 is a flowchart of the operations of a PVR consistent with another exemplary embodiment of the present invention;

FIG. 6 illustrates the configuration of a user interface provided by a PVR consistent with an exemplary embodiment of the present invention;

FIG. 7 illustrates the configuration of a user interface provided by a PVR consistent with another exemplary embodiment of the present invention; and

FIGS. 8 through 10 illustrate the states of a user interface in accordance with the operations of a PVR in an exemplary embodiment of the present invention.

### DETAILED DESCRIPTION OF NON-LIMITING EXEMPLARY EMBODIMENTS OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The present invention is described hereinafter with reference to flowchart illustrations of methods according to exemplary embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks. And each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

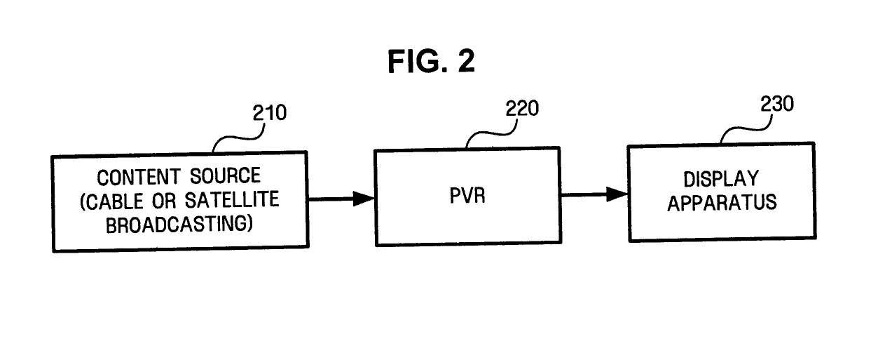

FIG. 2 illustrates a system enviroment including a private video recorder (PVR) 220 according to an exemplary embodiment of the present invention.

An exemplary system for an embodiment of the present invention includes a content source 210 such as a cable TV network, a satellite TV system, or a TV broadcasting station that provides contents to the PVR 220. The PVR 220 provides content from the content source 210 to a display apparatus 230 in real time so that a user can view the content.

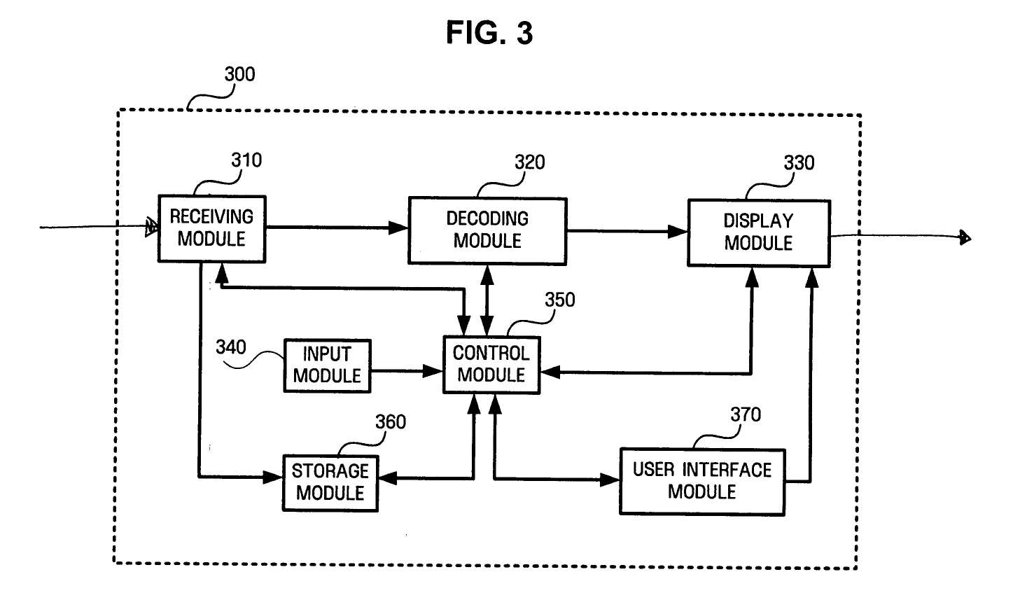

FIG. 3 is a block diagram of a PVR 300 according to an embodiment of the present invention.

The PVR 300 includes a receiving module 310, a decoding module 320, a display module 330, an input module 340, a control module 350, a storage module 360, and a user interface module 370.

The term ‘module’, as used herein includes, for example, a software or hardware component, such as a Field Programmable Gate Array (FPGA) or Application Specific Integrated Circuit (ASIC), which performs certain tasks, however, the term is not so limited. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute on one or more CPUs in a communication system.

The receiving module 310 receives content from the content source 210 (FIG. 2) and transmits the content to the decoding module 320. However, when a user presses a Pause button, the receiving module 310 transmits the received content to the storage module 360 to store the received content. The decoding module 320 decodes the content received from the receiving module 310 in an outputable form and transmits the decoded content to the display module 330. The input module 340 receives input data, e.g., Play, Pause, Rewind, or Fast Forward, from the user to control the operation of the PVR 300. The user interface module 370 converts storing status of the content changing in accordance with the operation of the PVR 300 responding to the user's input data into a user interface showing a history and provides the user interface to the display module 330. The display module 330 outputs the decoded content received from the decoding module 320 and the user interface received from the user interface module 370 to the display apparatus 230 (FIG. 2). The control module 350 controls the operation of each module of the PVR 300 according to the user's input data for operation control.

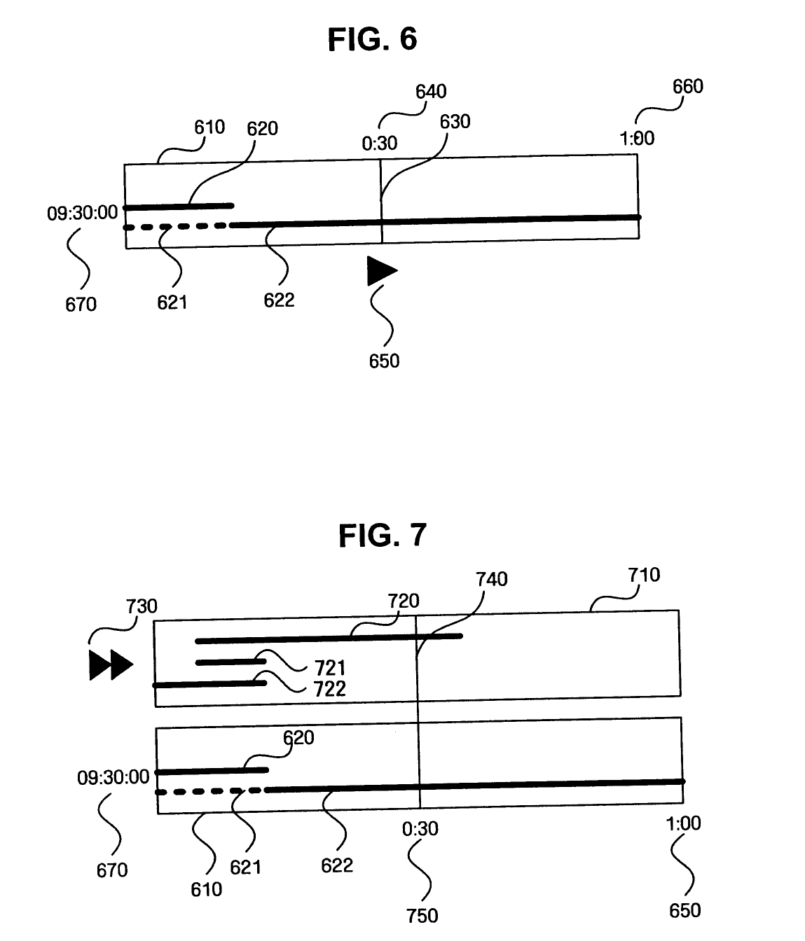

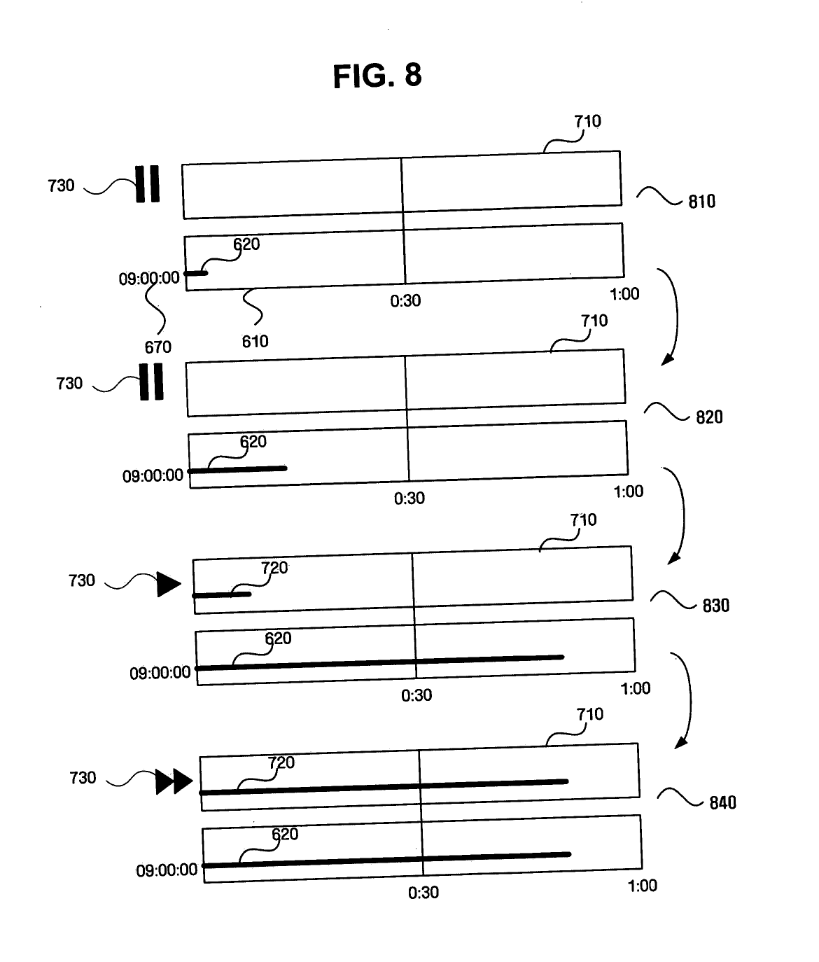

Alternatively, the user interface module 370 may generate a user interface showing a history of playing content according to the user's operation control as well as the storing status of the content and provide the user interface to the display module 330. The user interface showing the storing status of content and the playing history of the content will be described with reference to FIGS. 6 and 7 later.

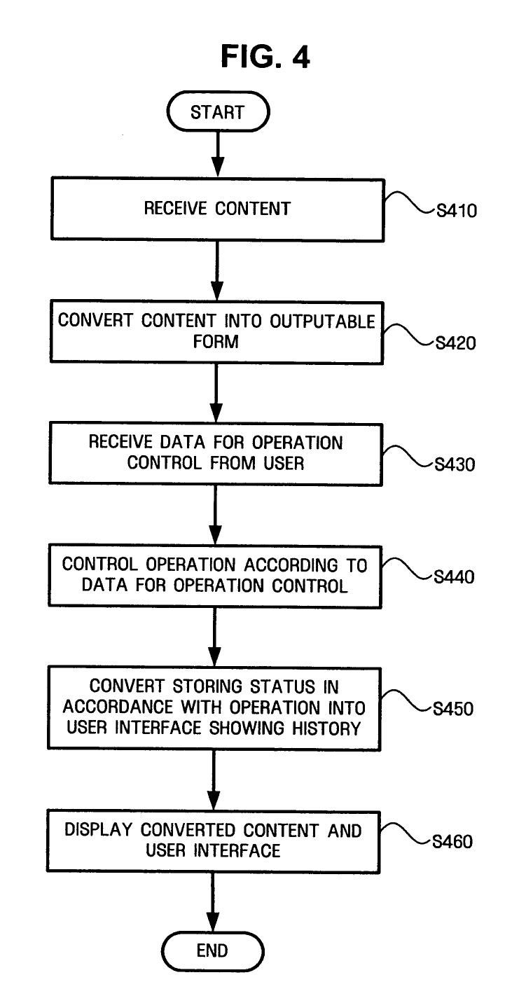

FIG. 4 is a flowchart of the operations of the PVR 300 shown in FIG. 3 according to an embodiment of the present invention.

When the receiving module 310 receives and transmits content to the decoding module 320 in operation S410, the decoding module 320 decodes the content in an outputable form in operation S420. When data for controlling the operation of the PVR 300 is received from a user in operation S430, the control module 350 controls the operation of the PVR 300 according to the data for operation control in operation S440. When the content is stored according to the operation of the PVR 300, the user interface module 370 generates a user interface showing the history of storing status in operation S450. The display module 330 displays the content decoded by the decoding module 320 and the user interface showing the storing status in operation S460. The user interface showing the storing status reflecting the history will be described with reference to FIG. 6 later.

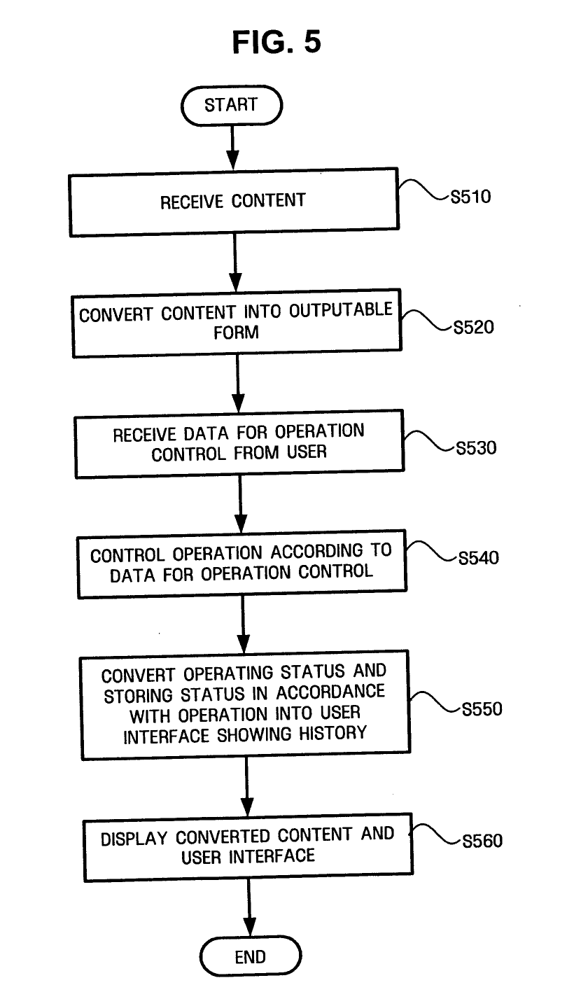

FIG. 5 is a flowchart of the operations of the PVR 300 shown in FIG. 3 according to another exemplary embodiment of the present invention. [36] Operations S510 through S540 are the same as operation S410 through S440 shown in FIG. 4. However, when the content is stored and then played by the operation of the PVR 300, the user interface module 370 converts storing status into a user interface showing a history and converts operating status such as Play into a user interface reflecting a history of a user's operation control in operation S550. The display module 330 displays the content decoded by the decoding module 320, the user interface showing the storing status, and the user interface showing the operating status such as Play in operation S560. The user interface showing the operating status reflecting the history will be described with reference to FIG. 7 later.

FIGS. 6 and 7 illustrate user interfaces provided by a PVR consistent with other exemplary embodiments of the present invention.

FIG. 6 illustrates a state where playing status of content is displayed in On Screen Display (OSD) user interface showing the history of storing status. The OSD user interface showing the history of storing status includes a bar 610 indicating an entire recordable capacity, lines 620, 621, and 622 showing the history of recording the content, a line 630 indicating a position that is played currently, a section 640 indicating a time corresponding to the position that is played currently, an icon 650 indicating current operating status, a section 660 indicating a period of time corresponding to the entire recordable capacity, and a section 670 indicating a recording start time.

In showing the history of recording the content, the solid line 620 shows a portion that has been recorded most recently and the end of the line 620 indicates a current recording position. The dotted line 621 indicates a portion that was recorded and then overwritten by the recently recorded portion indicated by the line 620. Accordingly, referring to FIG. 6, content was recorded for 1 hour and a portion of the content exceeding the entire recordable capacity has overwritten a portion of the content that had been recorded initially starting at 09:30. A user can immediately recognize from the dotted line 621 and the solid line 620 that a portion of content beyond one hour since when recording was started has been recorded.

In addition, the user can recognize that a portion of the content corresponding to the position of 30 minutes since the recording was started is played currently. Meanwhile, the overwritten portion may be denoted by a line, instead of the dotted line 621, having any form, for example, different color, different thickness, or different transparency, distinguished from a line indicating a remaining portion.

In addition, the lines 621, 622, and 620 showing the history of recording the content may not be displayed starting from a lower portion of the OSD user interface but may be displayed starting from an upper portion thereof. In other words, whenever overwriting is performed, the row of a line indicating the history of recording may be changed.

FIG. 7 illustrates a user interface combining an OSD user interface showing the history of storing status of content with an OSD user interface showing the history of playing status of the content.

The configuration of the OSD user interface showing the history of storing status of the content is the same as that of the OSD user interface shown in FIG. 6, with the exception that a line 740 and a section 750 that are located at the center of the bar 610 indicating the entire recordable capacity are an indicator line and an indicator time, respectively, for simple temporal division.

The OSD user interface showing the history of playing status of the content includes a bar 710 indicating playing status, lines 720, 721, and 722 indicating the history of played content, an icon 730 indicating current playing status, the indicator line 740 used for temporal division, and the section 750 indicating a time corresponding to the indicator line 740. The line 720 located at the top indicates a portion of the content that has been played most recently. The end of the line 720 indicates a position that is played currently. The lines 721 and 722 below the line 720 indicate portions that were played before. Accordingly, FIG. 7 shows that the portions of the content corresponding to the lines 721 and 722 were played and a portion of the content corresponding to the end of the line 720 located at the top is currently played in Fast Wind status. Therefore, a user can immediately recognize the history of playing the content from the past to the present.

Alternatively, the lines 722, 721, and 720 indicating the history of played content may be sequentially displayed in a temporal sequence starting from an upper portion instead of a lower portion of the OSD user interface showing the history of playing the content. In other words, the row of a line indicating the history of played content may change whenever a rewind occurs.

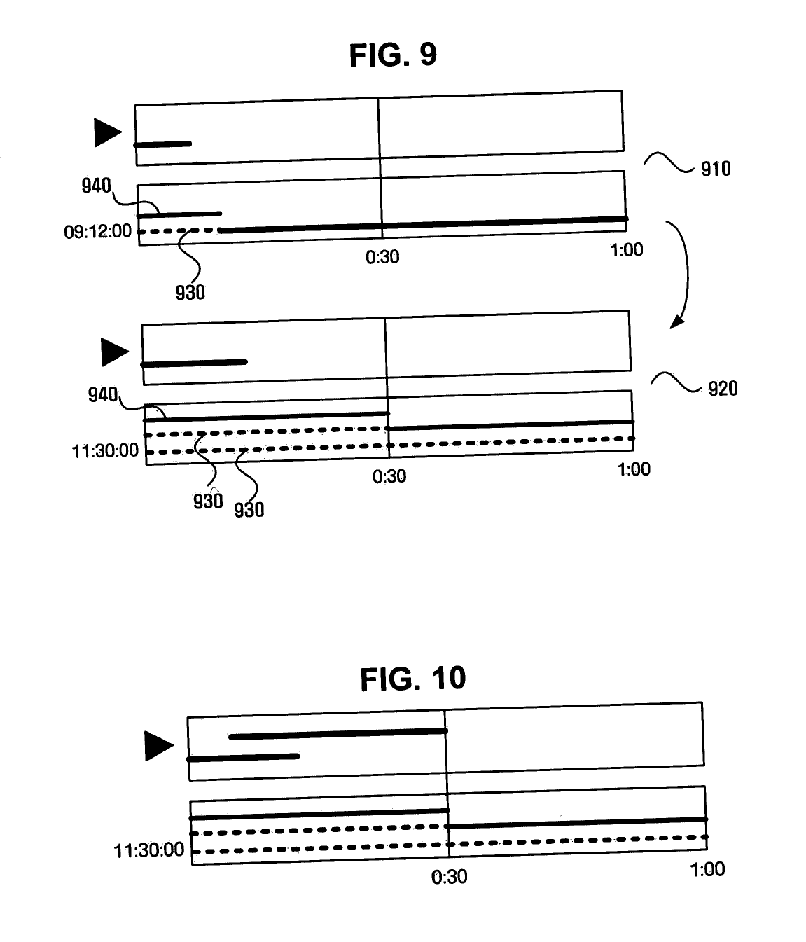

FIGS. 8 through 10 illustrate the states of a user interface in accordance with the operations of a PVR in an embodiment of the present invention.

FIG. 8 illustrates a user interface showing stages in which time shifting is started by a user pressing a Pause button while watching live TV and then the user views a recorded broadcast by pressing a Play button and a Fast Forward button. When the time shifting is started by the user pressing the Pause button while watching the live TV, the line 620 indicating the history of recorded content starts to be displayed in the bar 610 indicating the entire recordable capacity, the section 670 displays a recording start time, and the icon 730 indicating current playing status is marked as Pause, in stage 810. In Pause status, a screen is held still and content is continuously stored in a hard disc. Accordingly, the line 620 indicating the history of recorded content elongates and the end of the line 620 indicates a current recording position of the live TV, in stage 820. Thereafter, when the user presses the Play button and views the recorded content of the live TV, the line 720 indicating the history of played content starts to be displayed in the bar 710 indicating playing status in stage 830. Thereafter, when the user presses the Fast Forward button and catches up the current live TV in stage 840, a message noting that the live TV is returned is displayed and then the user interface showing both of the storing status and the playing status disappears.

FIG. 9 illustrates a user interface showing stages 910 and 920 in which overwriting is performed to store content after storable space in a hard disc has been filled. When the amount of content corresponding to an entire recordable capacity of 1 hour has been recorded, overwriting begins at an oldest portion of the recorded content and a recording start time is updated. An overwritten old portion is marked by a dotted line 930 and a new portion overwriting the old portion is marked by a solid line 940 above the dotted line 930.

FIG. 10 illustrates a user interface showing the history of playing status using two lines when a Rewind is performed after recorded content is played and then a Play is performed again.

According to the PVR and the method therefor, a user interface showing both of the history of storing status of content and the history of operating status of the PVR is provided so that a user can exactly recognize a portion of the content that is currently recorded and a portion of the content that is currently played.

In concluding the detailed description, those skilled in the art will appreciate that many variations and modifications can be made to the exemplary embodiments without substantially departing from the principles of the present invention. Therefore, the disclosed exemplary embodiments of the invention are used in a generic and descriptive sense only and not for purposes of limitation.

What is claimed is:

1. A private video recorder comprising:
a receiving module configured to receive content from a content source;
a decoding module configured to decode the received content;
a display module configured to output the decoded content;
a storage module configured to store at least one of the received content and the decoded content;
an input module configured to receive data for operation control from a user;
a control module configured to control operations of the receiving module, the decoding module, the display module and the storage module according to the data for operation control; and
a user interface module configured to generate a user interface showing a history of a storing status in the storage module and to provide the user interface to the display module.

2. The private video recorder of claim 1, wherein the user interface module is further configured to generate a user interface showing a history of an operating status of the private video recorder and to provide the user interface showing the history of the operating status to the display module.

3. The private video recorder of claim 2, wherein the user interface showing the history of the operating status comprises:
a bar indicating a playing status;
a line displayed within the bar to indicate a history of a played content; and
an icon indicating a current playing status.

4. The private video recorder of claim 3, wherein a row of the line indicating the history of the played content changes whenever a rewind occurs.

5. The private video recorder of claim 1, wherein the user interface showing the history of the storing status comprises:
a part showing a status of the recorded content; and
a part showing a status of a portion of the recorded content that is being played.

6. The private video recorder of claim 5, wherein the part showing the status of the recorded content comprises:
a bar indicating an entire amount of the recorded content;
a section indicating a period of time corresponding to the entire amount of the recorded content;
a line displayed within the bar to indicate a history of the recorded content; and
a section indicating a recording start time.

7. The private video recorder of claim 6, wherein in the line indicating the history of the recorded content, a portion of the line corresponding to an overwritten portion of the content has a form distinctive from a form of a portion of the line corresponding to a non-overwritten portion of the content.

8. The private video recorder of claim 6, wherein a row of the line indicating the history of the recorded content changes whenever overwriting is performed.

9. The private video recorder of claim 5, wherein the part showing the status of the portion that is being played comprises:
a line indicating a portion of the recorded content that is being played currently within the part showing the status of the recorded content;
a section indicating a time corresponding to the portion that is being played currently; and
an icon indicating a current operating status.

10. A method of providing a user interface showing a history of a storing status of a content in a private video recorder, the method comprising:
receiving content from a content source;
decoding the received content;
receiving data for operation control from a user;
controlling operations of the private video recorder according to the data for operation control;
generating the user interface showing the history of the storing status according to the controlled operations; and
outputting the decoded content and the user interface.

11. The method of claim 10, wherein the generating of the user interface comprises:
generating a user interface that shows the storing status of the received content; and
generating a user interface that shows a history of an operating status according to the controlled operations.

12. The method of claim 1 1, wherein the user interface showing the history of the operating status comprises:
a bar indicating a playing status;
a line displayed within the bar to indicate a history of a played content; and
an icon indicating a current playing status.

13. The method of claim 12, wherein a row of the line indicating the history of the played content changes whenever a rewind occurs.

14. The method of claim 10, wherein the user interface showing the history of the storing status comprises:
a part showing a status of a recorded content; and
a part showing a status of a portion of the recorded content that is being played.

15. The method of claim 14, wherein the part showing the status of the recorded content comprises:
a bar indicating an entire amount of the recorded content;
a section indicating a period of time corresponding to the entire amount of the recorded content;
a line displayed within the bar to indicate a history of the recorded content; and
a section indicating a recording start time.

16. The method of claim 15, wherein in the line indicating the history of the recorded content, a portion of the line corresponding to an overwritten portion of the content has a form distinctive from the form of a portion of the line corresponding to a non-overwritten portion of the content.

17. The method of claim 15, wherein a row of the line indicating the history of the recorded content changes whenever overwriting is performed.

18. The method of claim 14, wherein the part showing the status of the portion that is being played comprises:
a line indicating a portion of the recorded content that is being played currently within the part showing the status of the recorded content;
a section indicating a time corresponding to the portion that is being played currently; and
an icon indicating a current operating status.

19. A recording medium having a computer readable program recorded therein, the program enabling a computer to execute a method of providing a user interface showing a history of a storing status of a content in a private video recorder, the method comprising:
receiving content from a content source;
decoding the received content;
receiving data for operation control from a user;
controlling operations of the private video recorder according to the data for operation control;
generating the user interface showing the history of storing status according to the controlled operations; and
outputting the decoded content and the user interface.
